(19) United States
(12) Patent Application Publication
(10) Pub. No.: US 2012/0235433 A1
(43) Pub. Date: Sep. 20, 2012

(54) META-, PARA-ARAMID FIBER INDUSTRIAL WEBBING AND SLINGS

(75) Inventor: William J. Powers, Greenville, SC (US)

(73) Assignee: SOUTHERN WEAVING COMPANY, Greenville, SC (US)

(21) Appl. No.: 13/051,577

(22) Filed: Mar. 18, 2011

(51) Int. Cl. B66C 1/12; D03D 13/00; D03D 15/00

(52) U.S. Cl. 294/77; 442/181; 442/203

(57) ABSTRACT

The present invention is directed to an industrial product comprising a woven webbing of a meta-, para-aramid fiber.

### BACKGROUND OF THE INVENTION

### Field of the Invention

The present invention relates generally to industrial woven webbing comprising fibers or filaments based upon aromatic copolyamides.

### SUMMARY OF THE INVENTION

In an embodiment, the present invention is directed to a novel industrial sling comprising a woven webbing of meta-, para-aramid fibers. In some embodiments, the meta-, para-aramid fibers may comprise co-poly-(paraphenylene/3,4′-oxydiphenylene terephthalamide).

The invention is also directed, in an embodiment, to a method of using an industrial sling comprising a woven webbing of meta-, para-aramid fibers comprising: providing an industrial machine, tool, or part; positioning the sling such that it supports, contains, or holds the industrial machine, tool, or part; and exposing the sling to strong acids, strong bases, organic solvents, steam, or salt.

In yet another embodiment, the invention is directed to a chemically-resistant webbing for use in a strap, sling, or support comprising a woven webbing of meta-, para-aramid fibers.

### DETAILED DESCRIPTION OF THE PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Briefly, the invention is directed to industrial woven webbing comprising fibers or filaments based upon aromatic copolyamides. More specifically, the invention is directed to industrial woven narrow webbing comprising fibers or filaments based upon meta-, para-aramids.

Aramids are polyamides derived from aromatic acids and amines and are considered synthetic, organic fibers. Due to the stability of the aromatic rings and the added strength of the amide linkages, aramids exhibit higher tensile strength and thermal resistance than aliphatic polyamides. Meta-, para-aramids comprise a combination of meta- and para- linkages in their molecular structure. Compared to meta-aramids, the meta-, para-aramids have a greater tensile strength and abrasion resistance, lower shrinkage at high temperatures, and lower moisture regain. Compared to para-aramids, the meta-, para-aramids have greater chemical, elongation, and abrasion properties and also have a lower moisture regain.

In a particular embodiment of the invention, the meta-, para-aramid is co-poly-(paraphenylene/3,4′-oxydiphenylene terephthalamide), illustrated by the following chemical structure:

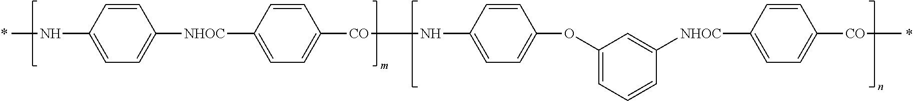

In addition to the properties listed above, the co-poly-(paraphenylene/3,4′-oxydiphenylene terephthalamide) fiber provides fatigue resistance as well as chemical and heat stability. During testing, the tensile strength of the co-poly-(paraphenylene/3,4′-oxydiphenylene terephthalamide) fiber was found to be higher than that of its para-aramid and meta-aramid counterparts. Its abrasion resistance, both in fiber-to-fiber and fiber-to-metal environments, was also found to be higher than that of a para-aramid fiber. Its flexural fatigue and hydrolysis resistance (factors in strength retention) were also found to be higher than that of para-aramid fibers. While reference is being made to co-poly-(paraphenylene/3,4′-oxydiphenylene terephthalamide) fiber, it is to be understood that any meta-, para-aramid fiber known in the art or yet to be discovered may be utilized in the present invention.

In an embodiment, the meta-, para-aramid fibers of the invention may be woven into an industrial webbing. The term “woven”, as used herein, means interlacing individual fibers in a regular order. Any method of weaving known in the art may be utilized in this invention. Similarly, any weave pattern known in the art may be utilized in the webbing including, but not limited to, a plain weave, a twill weave, a satin weave, a tabby weave, a taffeta weave, a matt weave, a basket weave, a rib weave, computer-generated interlacings, and combinations thereof.

The fiber of the invention may have any configuration known in the art. For example, the configuration of the fiber may be circular, ovular, elliptical, or flat.

In certain embodiments of the invention, the meta-, para-aramid fibers of the invention may be woven into a webbing with other fibers known in the art. In this embodiment, the other fibers may comprise para-aramid fibers, meta-aramid fibers, nylon, polyesters, polyolefins, amide polymers or copolymers, or combinations thereof.

In certain embodiments, the woven webbing is used to sew or otherwise manufacture a load-bearing strap, sling, or support. The strap, sling, or support may then be used for the containment, holding, or transportation of heavy aircraft, rigging, engine, shipbuilding, or other industrial or construction-related tools and parts.

In use as, and/or when being formed into, an industrially-acceptable product, the inventive strap, sling, or support may be immersed, bathed, pre-washed, or otherwise exposed to strong acids or bases. The exposure of the inventive products to such strong acids, strong bases, organic solvents, steam, or salt may be repetitive, subjecting the products to such elements many times. In addition, the exposure may occur for extended durations, including several minutes, several hours, several days, several weeks, several months, and/or several years or more.

In some embodiments, the strap, sling, or support may be used to suspend industrial parts which are pre-washed in caustic compounds and/or dipped into a penetrating dye bath for fault and defect inspections. Commercially available straps used in such a process are quickly degraded by such exposure, limiting the life and safety of the strap. In some cases, the strap may only be useful for a few hours before the critical minimum threshold of strength is breached and the straps must be replaced. The inventive straps, slings, or supports, however, have a high chemical stability to acids, bases, organic solvents, steam, and salt solutions that is not observed in commercially available products. As such, the woven webbing of the invention has a longer use life for applications where exposure to acids, bases, organic solvents, steam, or salts is anticipated. The inventors have discovered that, in some applications, the increase in use life may represent as much as a 10-fold increase in accumulated exposure before the critical minimum strength threshold is reached and the product must be removed from use.

In addition, the woven webbing and, therefore, straps, slings, or supports, are lighter in weight and have a higher tensile strength compared to similar products produced from meta-aramid fibers, para-aramid fibers, nylon, polyesters, polyolefins, and amide polymers or copolymers.

In a particular embodiment, the invention may comprise an industrial sling used to lift, move, and transport heavy loads. The industrial sling may be any type known in the art. In some embodiments, the sling may be a flat sling, a roundsling, a bridle sling, a roundsling cover, an endless sling, or an eye-to-eye (also known as “eye & eye”) sling. The webbing of the invention may also be utilized to manufacture or sew cover materials for a sling. In such an embodiment, the interior material of the sling may be referred to as the stuffier (see Table 2). The sling or cover materials may be single-layered or multiple-layered. In an embodiment, the webbing material is two-ply.

In an embodiment of the invention, the webbing may be in the range of about ¼ inch to about 10 inches in width. In another embodiment, the webbing may be about 1 inch to about 4 inches in width. In a particular embodiment, the webbing may be 1, 2, 3, or 4 inches in width.

In an embodiment, the minimum tensile strength of the webbing may be from about 2,000 lbs to about 50,000 lbs. In another embodiment, the minimum tensile strength of the webbing may be from about 8,000 lbs to about 36,000 lbs. In some embodiments, the tensile strength of the webbing may vary based upon the construction or width of the webbing. For example, the minimum tensile strength of the webbing may be as set forth in Tables 1-2.

TABLE 1

| 2-Ply Webbing Width | Minimum Tensile Strength (lbs) |
|---|---|
| 1 inch | 8,000 |
| 2 inches | 16,000 |
| 3 inches | 24,000 |
| 4 inches | 32,000 |

TABLE 2

| 2-Ply Webbing Cover Width | |
|---|---|
| (with stuffer) | Minimum Tensile Strength (lbs) |
| 1 inch | 12,000 |
| 2 inches | 20,000 |
| 3 inches | 28,000 |
| 4 inches | 36,000 |

In an embodiment, the sling may be industrially utilized directly with steel, stainless steel, nickel-based alloys, cobalt-based alloys, aluminum, magnesium, titanium, and titanium alloys.

In an embodiment, the fibers of the invention may be pretreated or lubricated prior to weaving. Any pretreatment or lubricant should not leach into the fiber or adhere to any metal surfaces during use of the woven product.

In another embodiment, the invention may include a process to apply dyes to the fibers, the woven webbing, or the final product. Any process known in the art for the dyeing of fibers, woven webbing, or woven products may be utilized. In some embodiments, the dye utilized provides additional UV resistance.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What is claimed is:

1. A webbing for use in an industrial sling comprising woven meta-, para-aramid fibers.

2. The webbing of claim 1 wherein the meta, para-aramid fiber comprises co-poly-(paraphenylene/3,4′-oxydiphenylene terephthalamide).

3. The webbing of claim 1 wherein the webbing comprises fibers in a weave pattern selected from the group consisting of a plain weave, a twill weave, a satin weave, a tabby weave, a taffeta weave, a matt weave, a basket weave, a rib weave, computer-generated interlacings, and combinations thereof.

4. The webbing of claim 1 wherein the webbing comprises at least one additional type of fiber selected from the group consisting of para-aramid fibers, meta-aramid fibers, nylon, polyesters, polyolefins, amide polymers or copolymers, and combinations thereof.

5. The webbing of claim 1 wherein the sling is adapted for use in containing, holding, or transporting heavy aircraft.

6. The webbing of claim 1 wherein the sling is adapted for use as parts for rigging, engines, ship, or other industrial or construction-related items.

7. The webbing of claim 1 wherein the sling is a flat sling, a roundsling, a bridle sling, a roundsling cover, an endless sling, or an eye-to-eye sling.

8. The webbing of claim 1 wherein the sling is a flat sling.

9. A method of using a sling comprising a woven webbing of a meta-, para-aramid fiber comprising:
a) providing an industrial machine, tool, or part;
b) positioning the sling such that it supports, contains, or holds the industrial machine, tool, or part; and
c) exposing the sling to strong acids, strong bases, organic solvents, steam, or salt.

10. The method of claim 9 wherein the exposure to such strong acids, strong bases, organic solvents, steam, or salt is repetitive.

11. The method of claim 9 wherein the exposure to such strong acids, strong bases, organic solvents, steam, or salt is for extended durations.

12. The method of claim 9 wherein the industrial machine, tool, or part comprises steel, stainless steel, a nickel-based alloy, a cobalt-based alloy, aluminum, magnesium, titanium, or a titanium alloy.

13. The method of claim 9 wherein the exposure step comprises immersing, bathing, or pre-washing the sling.

14. A strap, sling, or support product comprising a chemically-resistant webbing comprising meta-, para-aramid fibers.

15. The product of claim 14 wherein the meta, para-aramid fiber comprises co-poly-(paraphenylene/3,4′-oxydiphenylene terephthalamide).

16. The product of claim 14 adapted for use in containing, holding, or transporting heavy aircraft.

17. The product of claim 14 adapted for use as parts for rigging, engines, ship, or other industrial or construction-related items.

18. The product of claim 14 wherein the webbing comprises fibers in a weave pattern selected from the group consisting of a plain weave, a twill weave, a satin weave, a tabby weave, a taffeta weave, a matt weave, a basket weave, a rib weave, computer-generated interfacings, and combinations thereof.

19. The product of claim 14 wherein the product is a flat sling.

20. The product of claim 14 wherein the webbing comprises a meta-, para-aramid fiber and at least one other fiber selected from the group consisting of para-aramid fibers, meta-aramid fibers, nylon, polyesters, polyolefins, amide polymers or copolymers, and combinations thereof.
